(19) United States
(12) Patent Application Publication
(10) Pub. No.: US 2026/0257839 A1
(43) Pub. Date: Sep. 3, 2026

(54) LATCH MECHANISM FOR STORAGE CONTAINER

(71) Applicant: Buyers Products Company, Mentor, OH (US)

(72) Inventors: Tony Opperman, Mentor, OH (US); Dale Sly, Mentor, OH (US)

(73) Assignee: Buyers Products Company, Mentor, OH (US)

(21) Appl. No.: 19/068,201

(22) Filed: Mar. 3, 2025

(51) Int. Cl. B65D 43/22; B60R 5/00

(52) U.S. Cl. CPC B65D 43/22; B60R 5/00

(57) ABSTRACT

A latch system, for use with an associated storage container, including at least one opening mechanism, at least one catch mechanism, at least one latching member, at least one rod, at least one opening mechanism, and a catch interface. Also disclosed is a method for latching and unlatching an associated storage container.

### I. BACKGROUND

### A. Technical Field

This invention generally relates to methods and apparatuses related to utility trucks and other working vehicles and more specifically to methods and apparatuses related to a latch mechanism for use on utility truck storage containers and integrated toolboxes.

### B. Description of Related Art

Utility trucks and other working vehicles handle vast variety of different jobs and, as such, transport many different tools and articles of equipment to and from job sites. Toolboxes and storage containers have been used to reliably hold and organize such equipment. The toolboxes, whether free-standing or integrated into the vehicle, must be able to close and remain closed during transit.

Current toolboxes use latches to secure their lids closed, to prevent inadvertent opening and subsequent loss of cargo or tools, and to lock and prevent unauthorized access to the container's contents. Common latch assemblies utilize a three-bar construction to simultaneously latch or unlatch three or more mechanisms to unlock and open the container lid. This construction is insufficient. The unnecessary multiplicity of component parts gives rise to higher cost of materials, and the manufacture of such latch devices is made unnecessarily complex by the larger number of parts to connect and construct. Additionally, during operation, there are more potential points of failure and areas wherein the assembly could wear or break down.

What is needed is an apparatus that provides stable, secure closure of toolboxes and other storage containers, while mitigating possible points of failure, and providing a more cost-effective assembly.

### II. SUMMARY

In accordance with an aspect of the present invention, a latch system, for use with an associated storage container including at least one opening mechanism, at least one catch mechanism, at least one latching member disposed on an underside of a lid of the storage container, and at least one rod. Wherein, each rod may be configured to engage with the at least one opening mechanism on a first section of the rod, each rod may be configured to engage with at least one catch mechanism, on a second section of the rod, via a catch interface, and wherein the at least one catch mechanism may be configured to selectively lockably engage with the at least one latching member. The at least one catch mechanism may be configured to selectively rotate between a locked position and an unlocked position.

In accordance with another aspect of the invention, the latch system above, wherein, when the storage container lid is closed, the at least one catch mechanism may selectively rotate from the unlocked position to the locked position. When the at least one catch mechanism is in the locked position, the at least one catch mechanism may lockably engage with the at least one latching member. When the at least one opening mechanism is activated, the at least one catch mechanism may selectively rotate from the locked position to the unlocked position, and when the at least one catch mechanism is in the unlocked position, the at least one catch mechanism may be disengaged from the at least one latching member. Additionally, the latch system may further include a cover plate configured to fit over the at least one catch mechanism and the at least one rod, while still allowing the at least one latching member to engage with the at least one catch mechanism. The catch interface may include a “z” shaped bend on the second section of each rod, wherein the “z” shaped bend may be configured to be inserted into a throughhole on the at least one catch mechanism. The catch mechanism may include a locking member configured to engage with the at least one latching member, when the catch mechanism is in the locked position, to fix the storage container lid into a closed position. The catch member may include two actuating arms, and each of the two actuating arms may be configured to engage with the second sections of each of the rods.

In accordance with another aspect of the invention, the latch system above may further include a first rod and a second rod, and the first rod may be configured to engage with a first opening mechanism on a first side of the storage container, at a proximal end of the first rod. The first rod may be configured to engage with the at least one catch mechanism at a distal end of the first rod. Wherein, the second rod may be configured to engage with a second opening mechanism on a second side of the storage container, at a proximal end of the second rod, and the second rod may be configured to engage with the at least one catch mechanism at a distal end of the second rod. When the first opening mechanism is activated, the first rod may be slidably translocated towards the at least one catch mechanism, to rotate the at least one catch mechanism into the unlocked position, and when the second opening mechanism is activated, the second rod may be slidably translocated towards the at least one catch mechanism, to rotate the at least one catch mechanism into the unlocked position.

In accordance with another aspect of the invention, the latch system above may further include a first rod, a second rod, and a third rod, as well as a first catch mechanism and a second catch mechanism. The first rod may be configured to engage with a first opening mechanism on a first side of the storage container, at a proximal end of the first rod, and the first rod may be configured to engage with the first catch mechanism at a distal end of the first rod. Wherein the second rod may be configured to engage with the first catch mechanism at a first end of the second rod, and the second rod may be configured to engage with the second catch mechanism at a second end of the second rod. The third rod may be configured to engage with a second opening mechanism on a second side of the storage container, at a proximal end of the third rod, and the third rod may be configured to engage with the catch mechanism at a distal end of the third rod. When the first opening mechanism is activated, the first rod may be slidably translocated towards the first catch mechanism, to rotate the first catch mechanism into the unlocked position, and when the second opening mechanism is activated, the second rod may be slidably translocated towards the second catch mechanism, to rotate the second catch mechanism into the unlocked position. When the first catch mechanism is rotated into the unlocked position, the second catch mechanism may also be rotated into the unlocked position, and when the second catch mechanism is rotated into the unlocked position, the first catch mechanism may also be rotated into the unlocked position. In an alternative embodiment the at least one opening mechanism may be a button.

In accordance with another aspect of the invention, a method of latching an associated storage container, including the step of providing a latch system having at least one opening mechanism, at least one catch mechanism, at least one latching member disposed on an underside of a lid of the storage container, at least one rod, wherein each rod may be configured to engage with the at least one opening mechanism on a first section of the rod, each rod may be configured to engage with at least one catch mechanism, on a second section of the rod, via a catch interface. Wherein the at least one catch mechanism may be configured to selectively lockably engage with the at least one latching member, and the at least one catch mechanism may be configured to selectively rotate between a locked position and an unlocked position. Further steps may include closing the storage container lid to lockably engage the at least one catch mechanism with the at least one latching member and rotate the at least one catch member to the locked position, activating at least one opening mechanism to slidably translocate at least one rod towards the at least one catch mechanism, to rotate the at least one catch mechanism into the unlocked position, opening the storage container lid, repeating the step of closing, and repeating the steps of activating and opening, as needed.

In accordance with another aspect of the invention, the method above, wherein the latch system may further include a cover plate configured to fit over the at least one catch mechanism and the at least one rod, while still allowing the at least one latching member to engage with the at least one catch mechanism. The method above, wherein the catch interface may further include a “z” shaped bend on the second section of each of the at least one rod, and the “z” shaped bend may be configured to be inserted into a throughhole on the at least one catch mechanism. The method above, wherein the catch mechanism may further include a locking member configured to engage with the at least one latching member, when the at least one catch mechanism is in the locked position, to fix the storage container lid into a closed position, and two actuating arms, wherein each of the two actuating arms may be configured to engage with the second sections of each of the rods. The method above, wherein the at least one opening mechanism may be a button. The method above, wherein the at least one opening mechanism may be a lever.

In accordance with another aspect of the invention, a latch system, for use with an associated storage container, including at least one latching member disposed on an underside of a lid of the storage container and a first catch mechanism and a second catch mechanism, wherein the first catch mechanism and the second catch mechanism may be configured to selectively lockably engage with the at least one latching member. The first catch mechanism and the second catch mechanism may be configured to selectively rotate between a locked position and an unlocked position. The latch system may include a first rod, a second rod, and a third rod, wherein the first rod may be configured to engage with a first opening mechanism on a first side of the storage container, at a proximal end of the first rod, and the first rod may be configured to engage with the first catch mechanism at a distal end of the first rod. The second rod may be configured to engage with the first catch mechanism at a first end of the second rod, and the second rod may be configured to engage with the second catch mechanism at a second end of the second rod. Wherein the third rod may be configured to engage with a second opening mechanism on a second side of the storage container, at a proximal end of the third rod, and the third rod may be configured to engage with the catch mechanism at a distal end of the third rod. Each rod may be configured to engage with either of the first catch mechanism or second catch mechanism via a catch interface. When the storage container lid is closed, the first catch mechanism and the second catch mechanism may selectively rotate from the unlocked position to the locked position, and when the first catch mechanism and the second catch mechanism are in the locked position, the first catch mechanism and the second catch mechanism may be configured to lockably engage with the at least one latching member. When either of the first or second opening mechanism is activated, the first catch mechanism and the second catch mechanism nay selectively rotate from the locked position to the unlocked position, and when the first catch mechanism and the second catch mechanism are in the unlocked position, the first catch mechanism and the second catch mechanism are disengaged from the at least one latching member. When the first opening mechanism is activated, the first rod may be slidably translocated towards the first catch mechanism, to rotate the first catch mechanism into the unlocked position, and when the second opening mechanism is activated, the second rod may be slidably translocated towards the second catch mechanism, to rotate the second catch mechanism into the unlocked position. When the first catch mechanism is rotated into the unlocked position, the second catch mechanism may also be rotated into the unlocked position, and when the second catch mechanism is rotated into the unlocked position, the first catch mechanism may also be rotated into the unlocked position.

In accordance with another aspect of the invention, the latch system above, further including a cover plate configured to fit over the catch mechanism and the first and second rods, while still allowing the at least one latching member to engage with the catch mechanism. The latch system above, wherein the catch interface may further include a “z” shaped bend on the distal ends of each of the first and second rods, and on both ends of the third rod, wherein the “z” shaped bend may be configured to be inserted into a throughhole on the first catch mechanism and the second catch mechanism. The latch system above, wherein the catch mechanisms may include a locking member configured to engage with the at least one latching member, when the catch mechanisms are in the locked position, to fix the storage container lid into a closed position, two actuating arms, and wherein each of the two actuating arms may be configured to engage with the distal ends of each of the first and second rods, and both ends of the third rod. The latch system above, wherein the first and second opening mechanisms are buttons. The latch system above, wherein the first and second opening mechanisms are buttons.

Other benefits and advantages of this invention will become apparent to those skilled in the art to which it pertains upon reading and understanding of the following detailed specification.

### III. BRIEF DESCRIPTION OF THE DRAWINGS

The disclosed latch system may take physical form in certain parts and arrangement of parts, embodiments of which will be described in detail in this specification and illustrated in the accompanying drawings which form a part hereof and wherein:

FIG. 1 is a perspective view of a latch system according to some embodiments of this subject matter;

FIG. 2 is a close view of the latch system of FIG. 1, according to some embodiments of this subject matter;

FIG. 3 is a close top view of the latch system of FIG. 1, according to some embodiments of this subject matter;

FIG. 4 is another perspective view of the latch system of FIG. 1, showing a side of the associated storage container, according to some embodiments of this subject matter;

FIG. 5 is a close side view of an opening mechanism according to some embodiments of the present subject matter;

FIG. 6 is a top view of the opening mechanism of FIG. 5;

FIG. 7 is a perspective view of a second (104b) and a third (104c) rod according to some embodiments of the present subject matter.

### IV. DETAILED DESCRIPTION

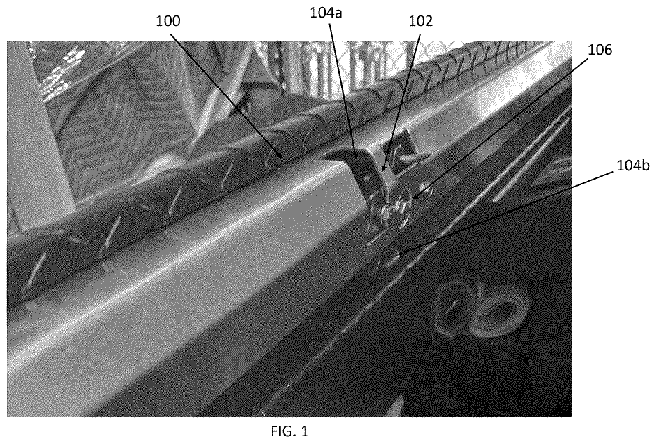

Referring now to the drawings, wherein the showings are for purposes of illustrating embodiments of the invention only and not for purposes of limiting the same, and wherein like reference numerals are understood to refer to like components, FIG. 1, shows a latch system 100 according to some embodiments of the present subject matter. The latch system 100 may include a catch mechanism 102 and rods 104a, 104b. The catch mechanism 102 may be any latching, securement, or locking apparatus chosen according to sound engineering judgment. In some embodiments of the present subject matter, the latch system 100 may include any number of catch mechanisms, chosen according to sound engineering judgment. In the same manner, the rods 104a, 104b may include any different possible construction or material, as well as including any number of rods, chosen according to sound engineering judgement. The latch system may or may not include fasteners 106, which fasteners 106 be any bolt, screw, rivet, or other fastening device, chosen according to sound engineering judgment. In a particular embodiment of the present device, the latch system may be constructed specifically without, or to the exclusion of, fasteners 106. The system 100 may further include an opening mechanism—which itself may include any button, lever, pulley, or other mechanism chosen according to sound engineering judgment—and a latching member disposed on the underside of an associated storage container's lid. The latching member may be any loop, hook, or other structure chosen according to sound engineering judgment and the overall structure of the latch system 100. In some embodiments of the present device, this disclosure contemplates any number of opening mechanisms, as well as any number of latching members, chosen according to sound engineering judgment. In particular embodiments, the number of latching members may correspond to the number of catch mechanisms. Note that by “associated,” it should be understood that the storage container need not be integral to the features and functions of the latch system 100 and that a potentially infringing device could meet the claimed features herein, even absent a storage container, if it otherwise meets the elements of the claim language.

It is to be appreciated that the present specification includes descriptions of similar components such as the rods 104a, 104b in which identical corresponding structures are described and given similar reference numerals. Insofar as both of such corresponding structures may not be shown clearly in a particular view, especially a detail view, it is to be understood and appreciated such corresponding structures resemble the structures that are clear shown in the views.

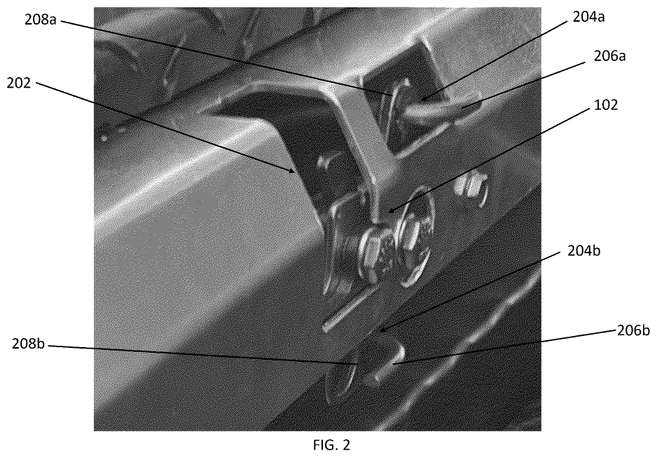

With reference to FIG. 2, the latch system 100 may include a catch interface 204a, 204b, which may include any mechanism allowing interaction between the rods 104a, 104b and the catch mechanism 102, chosen according to sound engineering judgment. The rods may each have a first end and a second end 206a, 206b. It is to be understood for purposes of this specification and disclosure that a rod 104a, 104b first end may encompass a proximal end, and a rod 104 a, 104b second end may encompass a distal end 206 a, 206 b, with reference to like numerals, and in certain embodiments. In a particular embodiment, the catch mechanism 102 may include actuating arms 208a,

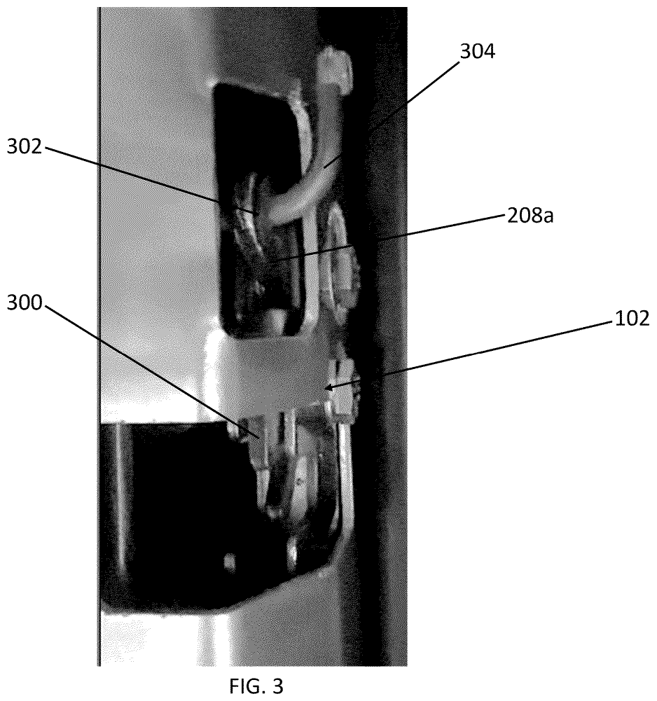

With reference to FIGS. 2 and 3, and in a particular embodiment, the catch interface 204a, 204b may include a throughhole 302, disposed on the catch mechanism 102, and a “z” shaped bend 304 disposed on the distal end 206a, 206b of each rod 104a, 104b. In a particular embodiment of the latch system 100, the “z” shaped bend 304 may preclude the necessity that clamps, clips, or other fasteners be included in the catch interface. The catch mechanism 102 may include a locking member 300. In a particular embodiment, a throughhole 302 may be disposed on each of the actuating arms 208a, 208b.

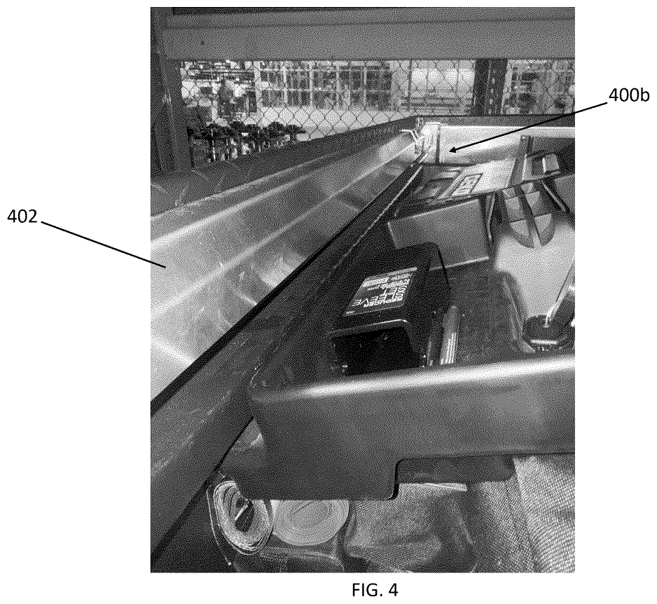

With reference to FIGS. 1, 3, and 4, the latch system 100 may include a cover plate, 400, which may be any shape, design, or material chosen according to sound engineering judgment. In particular embodiments, the cover plate may be designed such that it fits over the catch mechanism 102 and the rods 104a, 104b, while still allowing the latching member to engage with the catch mechanism 102.

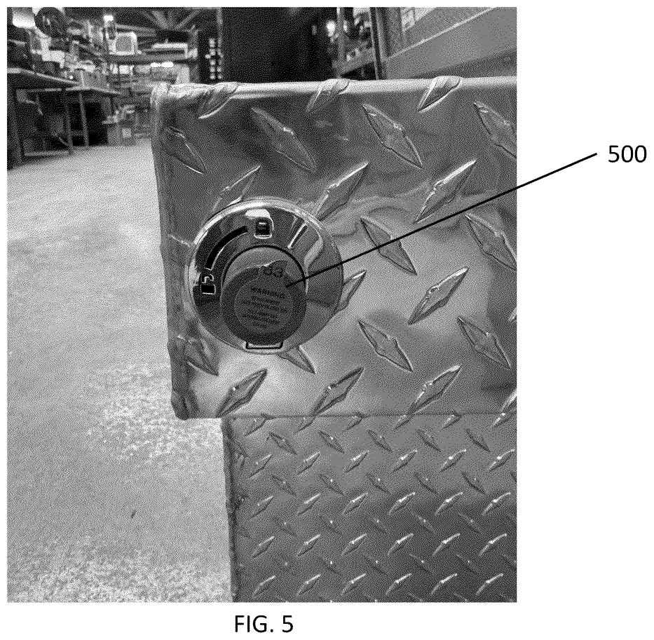

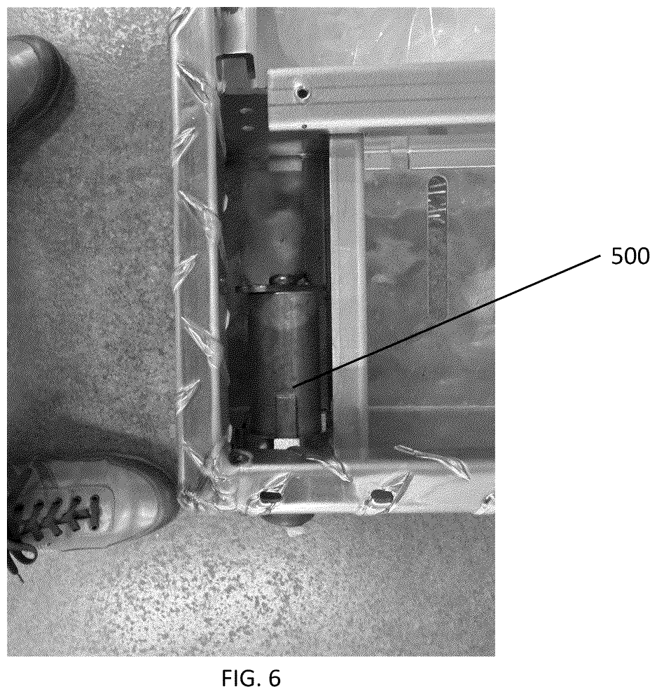

With reference to FIGS. 1, 2, 3, 4, 5, and 6, the latch system 100 components may operate together to secure the lid of an associated storage container. Each rod 104a, 104b may be configured to engage with the opening mechanism 500, at a first end of the rod 104a, 104b. The second end 206a, 206b of each rod 104a, 104b may be engaged with the catch mechanism 102, at a catch interface 204a, 204b. The catch mechanism 102 can lockably engage with the latching member, hooking, clipping, magnetically sealing, or otherwise being secured according to sound engineering judgment. The catch mechanism 102, itself, may selectively switch between a locked position and an unlocked position 202. In a particular embodiment, the catch mechanism 102 is a rotating mechanism that may selectively rotate between the locked and unlocked 202 positions. The latch system may include a first rod 104a and a second rod 104b, which may correspondingly engage with first and second opening mechanisms 500a, 500b, on first and second 400b sides of the storage container, respectively. In such case, the rods 104a, 104b may engage with the catch mechanism 102 at the rod distal ends 206a, 206b. The fasteners may function to secure the various latch system 100 components to a side—though, not necessarily the first or second 400b sides described herein—of an associated storage container.

In a particular embodiment, when the storage container lid is closed, the catch mechanism 102 selectively rotates from the unlocked position 202 to the locked position. In the locked position, the catch mechanism may lockably engage with the latching member. From there, a user may activate the opening mechanism 500 to selectively rotate the catch mechanism 102 from the locked position to the unlocked position 202, disengaging the catch mechanism 102 from the latching member. In a particular embodiment, the opening mechanism 500 may be a button, and in yet another embodiment, the opening mechanism 500 may be a lever. The latch system may include a first opening mechanism 500a and a second opening mechanism 500b, and either mechanism may be activated to similarly disengage the catch mechanism 102, as described herein. Either the first or second opening mechanism 500a, 500b may correspondingly engage with either of the first rod 104a or the second rod 104b. The rod that is so engaged may then, on a distal end 206a, 206b, which may be opposite the rod proximal end, engage the catch mechanism 102 at the respective catch interface 204a, 204b. In a particular embodiment, rod 104a, 104b engages with either of two actuating arms 208a, 208, at the rod distal (second) ends 206a, 206b.

By activating the opening mechanism 500, which may be disposed on either of the first or second 400b sides of an associated storage container, the corresponding rod 104a, 104b may be caused to engage with a corresponding actuator arm 208a, 208b. This causal engagement may be accomplished by shifting, sliding, or otherwise translocating—in any manner chosen according to sound engineering judgment—the corresponding rod 104a, 104b towards the catch mechanism 102. By engaging with the catch mechanism 102 (in some embodiments by virtue of the actuating arms 208a, 208b) the catch mechanism 102 may be selectively rotated into the unlocked position 202. The lid of the associated storage container may then be opened to access the storage container contents. By closing the lid, a user may once more secure the lid with the latch system 100 in the manner described above. In a particular contemplated embodiment, the latch system includes only two catch mechanism 102 and only three rods (a first rod 104a, a second rod 104b, as in the above embodiments, as well as a third rod 104c, which is not depicted in the attached figures but should be understood in the context described further below.), and it should be understood in the case of such an embodiment, the latch system is meant to specifically exclude inclusion of any quantity of catch mechanisms other than two and any quantity of rods other than three.

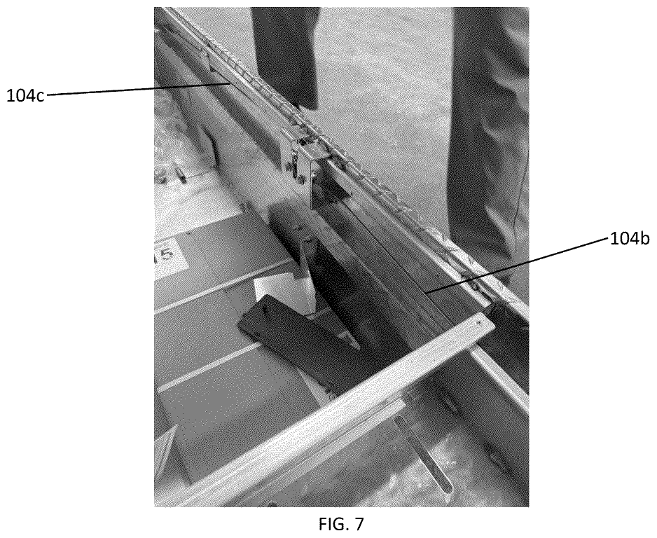

In a particular embodiment, and with reference to FIG. 7, the latch system 100 may include three rods 104a, 104b, 104c, and two catch mechanisms 102a, 102b. In this embodiment the first rod 104a and the second rod 104b function as described above, specifically with either of the corresponding first catch mechanism 102a and second catch mechanism 102b, respectively. The first rod 104a may extend from a first opening mechanism 500a on a proximal end of the first rod, to engage the first catch mechanism 102a at a catch interface 204a on the distal end 206a of the first rod 104a. The third rod 104c may extend between the first catch mechanism 102a and the second catch mechanism 102b, and include a catch interface 204c on each of the first end of the third rod 104c and the second end of the third rod 104c. The catch interfaces 204c of the third rod 104c may engage the first catch mechanism 102a and the second catch mechanism 102b, respectively. The second rod 104b may engage the second catch mechanism 102b at a catch interface 204b on the distal end 206b of the second rod 104b and extend from the second catch mechanism 102b to the second opening mechanism 500b at a proximal end of the second rod 104b. The latch system in this embodiment may function such that when either of the first or second opening mechanisms 500a, 500b is activated to engage either of the first or second rods 104a, 104b, the corresponding rod engages the corresponding first or second catch mechanism 102a, 102b to selectively rotate the corresponding catch mechanism 102a, 102b to the unlocked position 202. When the corresponding catch mechanism 102a, 102b is selectively rotated to the unlocked position, the catch mechanism 102a, 102b engages the third rod 104c to translocate the third rod 104c toward the other corresponding catch mechanism 102a, 102b to selectively rotate the other corresponding catch mechanism 102a, 102b to the unlocked position. In this manner, the third rod 104c, may operate to synchronize the rotational movement of the catch mechanisms 102a, 102b, as well as translocational movement of the rods 104a, 104b, 104c, when either of the first or second opening mechanisms 500a, 500b is activated. It should be understood that the first, second, and third rods 104a, 104b, 104c may be interchangeable, to the extent that the terms used to describe them (i.e., “first,” “second,” “third,” etc.) are arbitrary. Regarding similarity of structure and functionality, it should be understood that the either of the first and/or second rods (in this embodiment) are a similar structure and may serve a similar function whether attached to any of the first opening mechanism 500a and first catch mechanism 102a or the second opening mechanism 500b and second catch mechanism 102b.

Numerous aspects have been described, hereinabove. While the latch system 100 provided herein has been described in connection with various illustrative embodiments, it is to be understood that other similar embodiments may be used or modifications and additions may be made to the described embodiments for performing the same function disclosed herein without deviating therefrom. Further, all embodiments disclosed are not necessarily in the alternative, as various embodiments may be combined to provide the desired characteristics. It will be apparent to those skilled in the art that the above methods and apparatuses may incorporate changes and modifications without departing from the spirit and scope of the present disclosure. It is intended to include all such modifications and alterations in so far as they come within the scope of the appended claims or the equivalents thereof. Therefore, the holder apparatus should not be limited to any single embodiment, but rather construed in breadth and scope in accordance with the recitations of the appended claims.

Having thus described the invention, it is now claimed:

What is claimed:

1. A latch system, for use with an associated storage container, comprising:
at least one opening mechanism;
at least one catch mechanism;
at least one latching member disposed on an underside of a lid of the storage container;
at least one rod, wherein:
each rod is configured to engage with the at least one opening mechanism on a first section of the rod;
each rod is configured to engage with at least one catch mechanism, on a second section of the rod, via a catch interface;
wherein the at least one catch mechanism is configured to selectively lockably engage with the at least one latching member; and
wherein the at least one catch mechanism is configured to selectively rotate between a locked position and an unlocked position.

2. The latch system of claim 1, wherein:
when the storage container lid is closed, the at least one catch mechanism selectively rotates from the unlocked position to the locked position;
when the at least one catch mechanism is in the locked position, the at least one catch mechanism lockably engages with the at least one latching member;
when the at least one opening mechanism is activated, the at least one catch mechanism selectively rotates from the locked position to the unlocked position; and
when the at least one catch mechanism is in the unlocked position, the at least one catch mechanism is disengaged from the at least one latching member.

3. The latch system of claim 1, further comprising a cover plate configured to fit over the at least one catch mechanism and the at least one rod, while still allowing the at least one latching member to engage with the at least one catch mechanism.

4. The latch system of claim 1, wherein the catch interface comprises:
a “z” shaped bend on the second section of each rod; and
wherein the “z” shaped bend is configured to be inserted into a throughhole on the at least one catch mechanism.

5. The latch system of claim 1, wherein the catch mechanism comprises:
a locking member configured to engage with the at least one latching member, when the catch mechanism is in the locked position, to fix the storage container lid into a closed position;
two actuating arms; and
wherein each of the two actuating arms are configured to engage with the second sections of each of the rods.

6. The latch system of claim 1, further comprising:
a first rod and a second rod;
wherein the first rod is configured to engage with a first opening mechanism on a first side of the storage container, at a proximal end of the first rod, and wherein the first rod is configured to engage with the at least one catch mechanism at a distal end of the first rod;
wherein the second rod is configured to engage with a second opening mechanism on a second side of the storage container, at a proximal end of the second rod, and wherein the second rod is configured to engage with the at least one catch mechanism at a distal end of the second rod;
wherein:
when the first opening mechanism is activated, the first rod is slidably translocated towards the at least one catch mechanism, to rotate the at least one catch mechanism into the unlocked position; and
when the second opening mechanism is activated, the second rod is slidably translocated towards the at least one catch mechanism, to rotate the at least one catch mechanism into the unlocked position.

7. The latch system of claim 1, further comprising:
a first rod, a second rod, and a third rod;
a first catch mechanism and a second catch mechanism;
wherein the first rod is configured to engage with a first opening mechanism on a first side of the storage container, at a proximal end of the first rod, and wherein the first rod is configured to engage with the first catch mechanism at a distal end of the first rod;
wherein the second rod is configured to engage with the first catch mechanism at a first end of the second rod, and wherein the second rod is configured to engage with the second catch mechanism at a second end of the second rod;
wherein the third rod is configured to engage with a second opening mechanism on a second side of the storage container, at a proximal end of the third rod, and wherein the third rod is configured to engage with the catch mechanism at a distal end of the third rod;
wherein:
when the first opening mechanism is activated, the first rod is slidably translocated towards the first catch mechanism, to rotate the first catch mechanism into the unlocked position;
when the second opening mechanism is activated, the second rod is slidably translocated towards the second catch mechanism, to rotate the second catch mechanism into the unlocked position; and
when the first catch mechanism is rotated into the unlocked position, the second catch mechanism is also rotated into the unlocked position, and when the second catch mechanism is rotated into the unlocked position, the first catch mechanism is also rotated into the unlocked position.

8. The latch system of claim 1, wherein the at least one opening mechanism is a button.

9. A method of latching an associated storage container, comprising the steps of:
providing a latch system comprising:
at least one opening mechanism;
at least one catch mechanism;
at least one latching member disposed on an underside of a lid of the storage container;
at least one rod, wherein:
each rod is configured to engage with the at least one opening mechanism on a first section of the rod;
each rod is configured to engage with at least one catch mechanism, on a second section of the rod, via a catch interface;
wherein the at least one catch mechanism is configured to selectively lockably engage with the at least one latching member;
wherein the at least one catch mechanism is configured to selectively rotate between a locked position and an unlocked position;
closing the storage container lid to lockably engage the at least one catch mechanism with the at least one latching member and rotate the at least one catch member to the locked position;
activating at least one opening mechanism to slidably translocate at least one rod towards the at least one catch mechanism, to rotate the at least one catch mechanism into the unlocked position;
opening the storage container lid;
repeating the step of closing; and
repeating the steps of activating and opening, as needed.

10. The method of claim 9, wherein the latch system further comprises a cover plate configured to fit over the at least one catch mechanism and the at least one rod, while still allowing the at least one latching member to engage with the at least one catch mechanism.

11. The method of claim 9, wherein the catch interface comprises:
a “z” shaped bend on the second section of each of the at least one rod; and
wherein the “z” shaped bend is configured to be inserted into a throughhole on the at least one catch mechanism.

12. The method of claim 9, wherein the catch mechanism comprises:
a locking member configured to engage with the at least one latching member, when the at least one catch mechanism is in the locked position, to fix the storage container lid into a closed position;
two actuating arms; and
wherein each of the two actuating arms are configured to engage with the second sections of each of the rods.

13. The method of claim 9, wherein the at least one opening mechanism is a button.

14. The method of claim 9, wherein the at least one opening mechanism is a lever.

15. A latch system, for use with an associated storage container, comprising:
at least one latching member disposed on an underside of a lid of the storage container;
a first catch mechanism and a second catch mechanism;
wherein the first catch mechanism and the second catch mechanism are configured to selectively lockably engage with the at least one latching member;
wherein the first catch mechanism and the second catch mechanism are configured to selectively rotate between a locked position and an unlocked position;
a first rod, a second rod, and a third rod;
wherein the first rod is configured to engage with a first opening mechanism on a first side of the storage container, at a proximal end of the first rod, and wherein the first rod is configured to engage with the first catch mechanism at a distal end of the first rod;
wherein the second rod is configured to engage with the first catch mechanism at a first end of the second rod, and wherein the second rod is configured to engage with the second catch mechanism at a second end of the second rod;
wherein the third rod is configured to engage with a second opening mechanism on a second side of the storage container, at a proximal end of the third rod, and wherein the third rod is configured to engage with the catch mechanism at a distal end of the third rod;
each rod is configured to engage with either of the first catch mechanism or second catch mechanism via a catch interface;
wherein:
when the storage container lid is closed, the first catch mechanism and the second catch mechanism selectively rotate from the unlocked position to the locked position;
when the first catch mechanism and the second catch mechanism are in the locked position, the first catch mechanism and the second catch mechanism are configured to lockably engage with the at least one latching member;
when either of the first or second opening mechanism is activated, the first catch mechanism and the second catch mechanism selectively rotate from the locked position to the unlocked position; and
when the first catch mechanism and the second catch mechanism are in the unlocked position, the first catch mechanism and the second catch mechanism are disengaged from the at least one latching member;
when the first opening mechanism is activated, the first rod is slidably translocated towards the first catch mechanism, to rotate the first catch mechanism into the unlocked position;
when the second opening mechanism is activated, the second rod is slidably translocated towards the second catch mechanism, to rotate the second catch mechanism into the unlocked position; and
when the first catch mechanism is rotated into the unlocked position, the second catch mechanism is also rotated into the unlocked position, and when the second catch mechanism is rotated into the unlocked position, the first catch mechanism is also rotated into the unlocked position.

16. The latch system of claim 15, further comprising a cover plate configured to fit over the catch mechanism and the first and second rods, while still allowing the at least one latching member to engage with the catch mechanism.

17. The latch system of claim 15, wherein the catch interface comprises:
a “z” shaped bend on the distal ends of each of the first and second rods, and on both ends of the third rod; and
wherein the “z” shaped bend is configured to be inserted into a throughhole on the first catch mechanism and the second catch mechanism.

18. The latch system of claim 15, wherein the catch mechanisms comprise:
a locking member configured to engage with the at least one latching member, when the catch mechanisms are in the locked position, to fix the storage container lid into a closed position;
two actuating arms; and
wherein each of the two actuating arms are configured to engage with the distal ends of each of the first and second rods, and both ends of the third rod.

19. The latch system of claim 15, wherein the first and second opening mechanisms are buttons.

20. The latch system of claim 15, wherein the first and second opening mechanisms are buttons.
